(19) United States
(12) Patent Application Publication
(10) Pub. No.: US 2014/0214883 A1
(43) Pub. Date: Jul. 31, 2014

(54) KEYWORD TRENDING DATA

(71) Applicant: Google Inc., (US)

(72) Inventors: Larry G. Sanderson, Los Altos, CA (US); Alexandru I. Banceanu, Los Altos, CA (US); Ajit Apte, Mountain View, CA (US); Cristian Susanu, Mountain View, CA (US); Christopher G. Suter, Mountain View, CA (US)

(73) Assignee: Google Inc., Mountain View, CA (US)

(21) Appl. No.: 13/752,824

(22) Filed: Jan. 29, 2013

(51) Int. Cl. G06F 17/30

(52) U.S. Cl. CPC G06F 17/30424
USPC 707/769

(57) ABSTRACT

Methods, systems, and apparatus, including computer programs encoded on a computer storage medium, for distributing content. In one aspect, a method includes identifying a set of keywords for one or more content items that are included in a content distribution campaign. Keyword trend data for the set of keywords are obtained. The keyword trend data specify, for each of one or more keywords in the set of keywords, a query volume indicative of a number of matching search queries that have been received, at a search system, over a specified period. For a particular keyword from the set of keywords, a determination is made that the keyword trend data meets a distribution parameter change condition. In response to determining that the keyword trend data meets a distribution parameter change condition, a distribution parameter that controls distribution of at least one of the content items is adjusted.

### BACKGROUND

This specification relates to data processing and content distribution.

The Internet provides access to a wide variety of resources. For example, video and/or audio files, as well as web pages for particular subjects or that present particular news articles are accessible over the Internet. To identify resources that may satisfy a user's informational need, the user can submit a search query to a search system and receive a search results page that identifies one or more resources. The search results page can include “slots” (i.e., specified portions of the web page) in which advertisements (or other content items) can be presented. Advertisements or other content items that are presented in the slots are selected for presentation by a content distribution system that can perform an auction as part of the selection process.

### SUMMARY

In general, one innovative aspect of the subject matter described in this specification can be embodied in methods that include the actions of identifying a set of keywords for one or more content items that are included in a content distribution campaign, the set of keywords including at least one keyword that must be matched by data included in a content item request for the content item to be distributed in response to the content item request; obtaining keyword trend data for the set of keywords, the keyword trend data specifying, for each of one or more keywords in the set of keywords, a query volume indicative of a number of matching search queries that have been received, at a search system, over a specified period; determining, for a particular keyword from the set of keywords, that the keyword trend data meets a distribution parameter change condition; and adjusting, in response to determining that the keyword trend data meets a distribution parameter change condition, a distribution parameter that, in combination with the particular keyword, controls distribution of at least one of the content items. Other embodiments of this aspect include corresponding systems, apparatus, and computer programs, configured to perform the actions of the methods, encoded on computer storage devices.

These and other embodiments can each optionally include one or more of the following features. Obtaining keyword trend data for the set of keywords can include obtaining, for each keyword among the one or more keywords, a measure of query volume over a specified period, the measure of query volume specifying, for the specified period, a volume of queries received for the specified period relative to a baseline query volume for the keyword.

Determining that the keyword trend data meets a distribution parameter change condition can include receiving, for the particular keyword, a distribution parameter change condition specifying a minimum change in query volume that must occur, from a first specified period to a second specified period, for the distribution change condition to be met; and determining, based on the keyword trend data, that the change in query volume for the particular keyword meets the minimum change in query volume.

Methods can include the actions of determining, based on the keyword trend data, a query volume dependent bid for a particular keyword. Adjusting the distribution parameter can include setting a bid for the particular keyword to the query volume dependent bid.

Determining the query volume dependent bid can include computing a value for the query volume dependent bid based on the query volume for the particular keyword, the computed value being proportional to the query volume.

Determining that the keyword trend data meets the distribution parameter change condition can include determining, for the particular keyword, that the query volume meets a specified query volume. Setting the bid for the particular keyword can include setting the bid for the particular keyword to a value that has been specified as the volume dependent bid for the specified query volume.

Methods can include the actions of receiving a distribution start condition specifying that the particular keyword becomes eligible to control distribution of content items when an increase in the query volume for the particular keyword meets a specified query volume; and determining that the query volume for the particular keyword meets the specified query volume. Adjusting the distribution parameter can include enabling the particular keyword to control distribution of a content item in the content distribution campaign, the adjusting being performed in response to determining that the query volume for the particular keyword meets the specified query volume.

Methods can include the actions of providing a user interface that includes an automate menu in which the distribution parameter change condition is defined; and receiving, through the user interface, the distribution parameter change condition, the received distribution parameter change condition specifying at least one action that is to be performed in response to determining that the query volume for a particular keyword meets a specified query volume.

Particular embodiments of the subject matter described in this specification can be implemented so as to realize one or more of the following advantages. Enabling content distribution parameters to be automatically changed based on changes to keyword trend data. Enabling advertisers (and other content distributors) to start or stop distribution of their content when keyword trend data meets specified criteria.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which content distribution system distributes content to user devices.

FIGS. 2A-2D are screen shots of an example user interface with which an advertiser can manage distribution of advertisements based on query trend data.

FIG. 3 is a flow chart of an example process for adjusting distribution campaign parameters based on distribution parameter change conditions.

FIG. 4 is block diagram of an example computer system that can be used to perform operations described above.

Like reference numbers and designations in the various drawings indicate like elements.

### DETAILED DESCRIPTION

Advertisers (or other content item providers) are provided with keyword trend data that can be used to adjust distribution parameters for an advertisement campaign (or another content item distribution campaign). The keyword trend data for each of the advertiser's keywords specify a volume of user queries that have matched the keyword over a specified time period. The volume can be normalized relative to an average volume of user queries that have been historically been received over the specified time period.

The advertiser can create distribution parameter change conditions that, when met, cause a system to automatically adjust parameters of the campaign based on the keyword trend data. For example, an advertiser can create a distribution parameter change condition that starts (e.g., enables) a campaign or enables a keyword when the volume of matching queries for the keyword meets a specified threshold and/or when a change in the query volume from one period to the next meets a threshold change. The advertiser can also specify a query volume dependent bid for a particular keyword that changes with changes in query volume for the keyword. To facilitate creation of the distribution parameter change conditions, the advertiser is provided with a user interface that enables the advertiser to specify actions to be taken in response to determining that the query volume for a keyword meets a specified threshold.

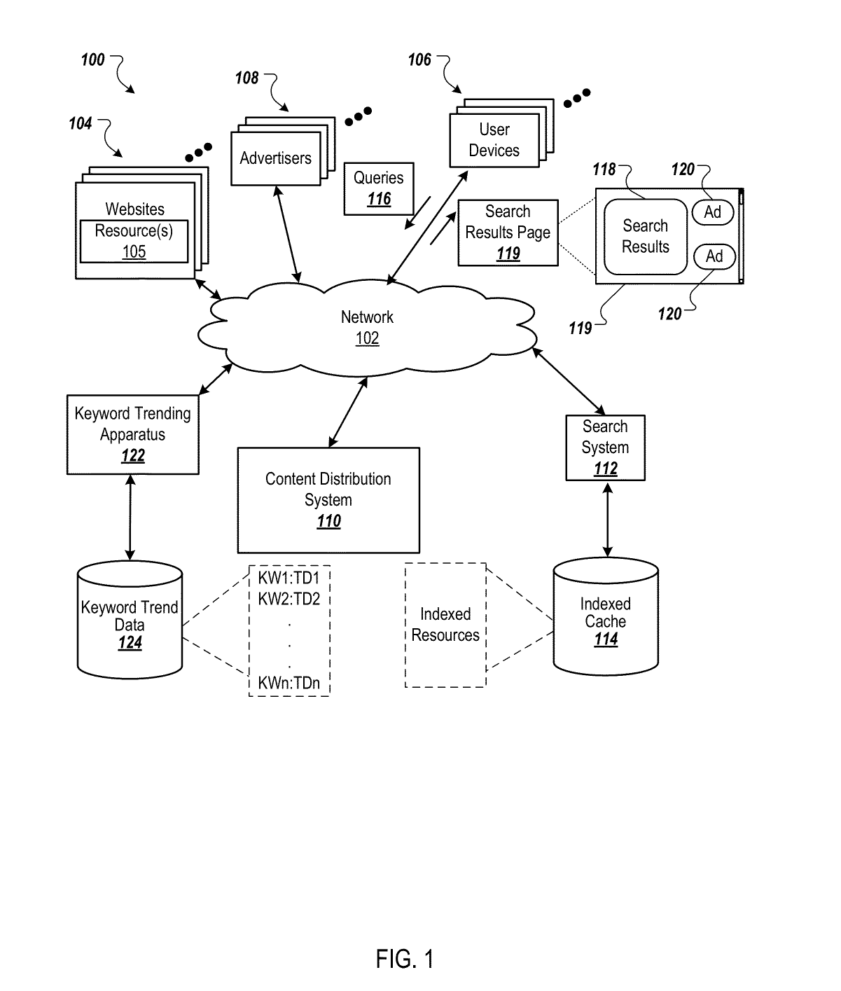

FIG. 1 is a block diagram of an example environment 100 in which content distribution system 110 distributes content to user devices 106. The example environment 100 includes a network 102 such as a local area network (LAN), wide area network (WAN), the Internet, or a combination thereof. The network 102 connects websites 104, user devices 106, advertisers 108, and the advertisement management system 110. The example environment 100 may include millions of websites 104, user devices 106, and advertisers 108.

A website 104 is one or more resources 105 associated with a domain name and hosted by one or more servers. An example website is a collection of web pages formatted in hypertext markup language (HTML) that can contain text, images, multimedia content, and programming elements, e.g., scripts. Each website 104 is maintained by a publisher, e.g., an entity that manages and/or owns the website 104.

A resource 105 is data provided by the website 104 over the network 102 and that is associated with a resource address. Resources include HTML pages, word processing documents, and portable document format (PDF) documents, images, video, and feed sources, to name only a few. The resources can include content, e.g., words, phrases, images and sounds that may include embedded information (such as meta-information in hyperlinks) and/or embedded instructions (such as scripts).

A user device 106 is an electronic device that is under control of a user and is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display (e.g., a presentation location of a pop-up window or in a slot of a web page) in which advertisements can be presented. These specified portions of the resource or user display are referred to as advertisement slots.

To facilitate searching of these resources, the environment can include a search system 112 that identifies the resources by crawling and indexing the resources provided by the publishers on the websites 104. Data about the resources can be indexed based on the resource to which the data corresponds. The indexed and, optionally, cached copies of the resources are stored in an indexed cache 114.

User devices 106 can submit search queries 116 to the search system 112 over the network 102. In response, the search system 112 accesses the indexed cache 114 to identify resources that are relevant to the search query 116 (e.g., have at least a threshold relevance score with respect to the search query). The search system 112 identifies the resources in the form of search results 118 and returns the search results 118 to the user devices 106 in search results pages 119. A search result 118 is data generated by the search system 112 that identifies a resource that is responsive to a particular search query, and includes a link to the resource. An example search result 118 can include a web page title, a snippet of text or a portion of an image extracted from the web page, and the URL of the web page. Search results pages 119 can also include one or more advertisement slots 120 in which advertisements can be presented. The advertisement slots 120 can also facilitate presentation of other content items instead of, or in addition to, advertisements.

When search results 118 are requested by a user device 106, the content distribution system 110 receives an advertisement request (or another content item request) requesting advertisements (or another content item) to be provided with the search results 118. The advertisement request can include characteristics of the advertisement slots 120 that are defined for the search results page 119. For example, a size of the advertisement slot 120, and/or media types that are eligible for presentation in the advertisement slot 120 can be provided to the content distribution system 110. Similarly, data specifying one or more terms of the search query 116 in response to which the search results page 119 is being provided can also be included in the advertisement request to facilitate identification of advertisements that are relevant to the search query 116.

Based on data included in the advertisement request, the content distribution system 110 selects advertisements that are eligible to be provided in response to the advertisement request (“eligible advertisements”). Eligible advertisements can include, for example, advertisements having characteristics that match the characteristics of the advertisement slots 118 and that are identified as relevant to the search query 116.

In some implementations, advertisements that are selected as eligible advertisements by the content distribution system 110 are those advertisements having distribution attributes (i.e., data with which distribution of the advertisement is managed) that match the search query 116 and/or other selection criteria included in the advertisement request. The advertisement management system 110 can select, from the set of eligible advertisements, one or more advertisements for presentation with the search results page 119. Each advertisement can be selected for presentation based, at least in part, on how well a distribution keyword (also referred to as a keyword) for the advertisement matches the search query and/or on the outcome of an auction.

A distribution keyword can match a search query by having the same textual content (“text”) as the search query. For example, an advertisement (or another content item) associated with the distribution keyword “basketball” can be selected for presentation with a search results page that is provided in response to the search query “basketball,” since the search query and the distribution keyword are exactly the same. This is referred to as an exact match.

A distribution keyword can also match a search query by having text that is identified as being sufficiently relevant, or sufficiently similar, to the search query despite having different text than the search query. For example, an advertisement (or another content item) associated with the distribution keyword “basketball” may also be selected for presentation with a search results page that is provided in response to the search query “sports” because basketball is a type of sport, and, therefore, is relevant to the term “sports.”

For purposes of this document, a distribution keyword can be considered to match a search query when a measure of similarity (e.g., semantic or topical similarity) between the distribution keyword and the search query meets a specified threshold value. The measure of similarity can be specified based on a cosine distance between the attributes of the search query and the attributes of the distribution keyword, an edit distance between the search query and the distribution keyword, user feedback specifying a measure of similarity between the search query and the distribution keyword, or another indication of similarity between the search query and the distribution keyword (e.g., each of the search query and the distribution keyword being categorized to a same topic in a topical hierarchy).

The content distribution system 110 can also select advertisements for presentation in advertisement slots 120 of a search results page 119 based on results of an auction. For example, the content distribution system 110 can receive bids from advertisers and allocate the advertisement slots to the highest bidders at the conclusion of the auction. The bids are amounts that the advertisers are willing to pay for presentation (or selection) of their advertisement with a search results page. For example, a bid can specify an amount that an advertiser is willing to pay for each 1000 impressions (e.g., presentations) of the advertisement, referred to as a CPM bid. Alternatively, the bid can specify an amount that the advertiser is willing to pay for a user interaction with (e.g., a click-through of or hovering a pointer over) the advertisement or a “conversion” following user interaction with the advertisement. A conversion occurs when a user consummates a transaction related to an advertisement being provided with a search results page. What constitutes a conversion may vary from case to case and can be determined in a variety of ways.

Many different types of auctions can be used to select the advertisements (or other content items) for presentation. First price auctions, generalized second price (GSP) auctions and Vickery-Clarke-Groves auctions are a few examples of auctions that can be performed by the content distribution system 110 to select advertisements (or other content items) for presentation.

There may be times at which a particular advertiser is more interested in presenting their advertisements that are relevant to a particular topic. The times at which a particular advertiser wants to promote certain merchandise may be seasonal. For example, an advertiser that sells team merchandise, such as replica sports jerseys or branded attire for various sports teams, may prefer that their merchandise for football teams be promoted more during football season and prefer that their merchandise for baseball attire be promoted more during baseball season.

The times at which a particular advertiser wants to promote certain merchandise can also be based on the user interest in topics related to the merchandise. For example, the particular advertiser may be more interested in presenting advertisements for a particular team's merchandise when that particular team is of more interest to the users of the search system and less interested when user interest in the team is lower. However, it can be difficult for an advertiser to determine the level of user interest in multiple different topics in a timely fashion. It can also be difficult for an advertiser to continually adjust distribution parameters for multiple different advertisements as user interest in the topics changes over time.

The environment 100 includes a keyword trending apparatus 122 that adjusts distribution parameters for advertisements (or other content items) based on changes to user interest in topics to which the advertisements are related. The keyword trending apparatus obtains keyword trend data 124 that specify, for each of a plurality of distribution keywords, a query volume indicative of a number of matching search queries that have been received at the search system 112.

The number of search queries that match a particular distribution keyword is considered to be an indication of user interest in topics to which the distribution keyword is related. For example, user interest in topics related to a particular distribution keyword is considered to increase as the number of search queries that match that particular distribution keyword increases. For brevity, user interest in topics to which a distribution keyword is related is referred to throughout this document as user interest in the distribution keyword.

The query volume can be tracked over specified periods, or intervals, (e.g., 1 hour, 1 day, or 1 week) to determine whether user interest over a current (or most recent) period has increased or decreased relative to one or more previous periods. For example, assume that over one particular day 750,000 matching search queries for a particular distribution keyword (i.e., search queries that matched the particular distribution keyword) were received by the search system 112. Further assume that on a subsequent day 1,500,000 matching search queries were received for the particular distribution keyword. In this example, the number of matching search queries that were received increased by 100%, such that user interest in the particular distribution keyword is considered to have increased by 100% from the particular day to the subsequent day. Therefore, the popularity of the particular distribution keyword is considered to have trended up from the particular day to the subsequent day, and this upward trend for the particular distribution keyword can be specified in the keyword trend data for this particular distribution keyword.

In some implementations, the query volume for a particular distribution keyword is a value indicating the number of matching search queries for the particular distribution keyword relative to a baseline number of matching search queries for the particular distribution keyword. For example, assume that for a particular distribution keyword, the daily average (or another measure of central tendency) number of matching search queries is 1,000,000. In this example, the query volume for the particular day over which 750,000 matching search queries are received can be 0.75 (e.g., number of matching queries for particular day/daily average number of matching search queries, which is 750,000/1,000,000), while the query volume for the subsequent day over which 1,500,000 matching search queries can be 1.5 (e.g., 1,500,000/1,000,000). The query volume can also be expressed as a percentage of a maximum query volume that has occurred over a specified period.

As described in more detail below, the keyword trending apparatus 122 can allow an advertiser (or another content item provider) to specify changes to an advertisement campaign (or another content distribution campaign) to be made when the keyword trend data for a particular keyword meets a distribution parameter change condition. The distribution parameter change condition can specify, for example, a query volume value and/or a query volume change that will trigger advertiser specified changes to the advertisement campaign. For example, the distribution parameter change condition can specify that when a query volume, or change in query volume from one period to another, for a particular distribution keyword meets a specified threshold, the particular distribution keyword can be activated (or deactivated) for one or more advertisements. Similarly, the distribution parameter change condition can specify a change to the bid for the particular distribution keyword be made when the query volume, or a change in query volume, for the particular distribution keyword meets a threshold.

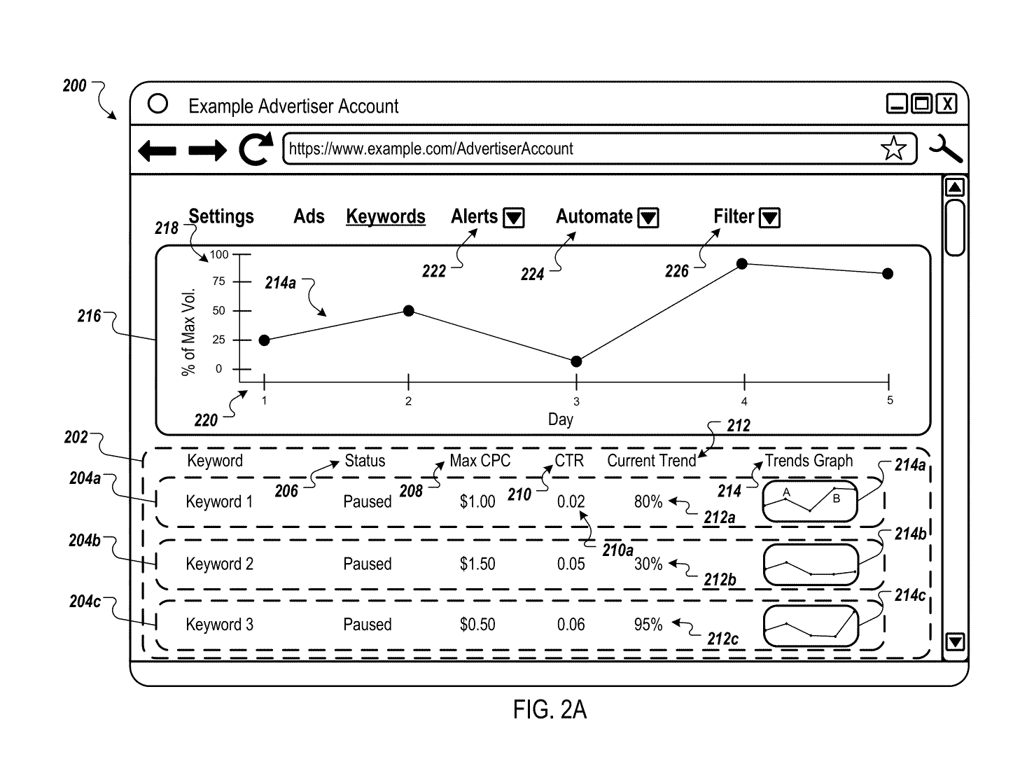

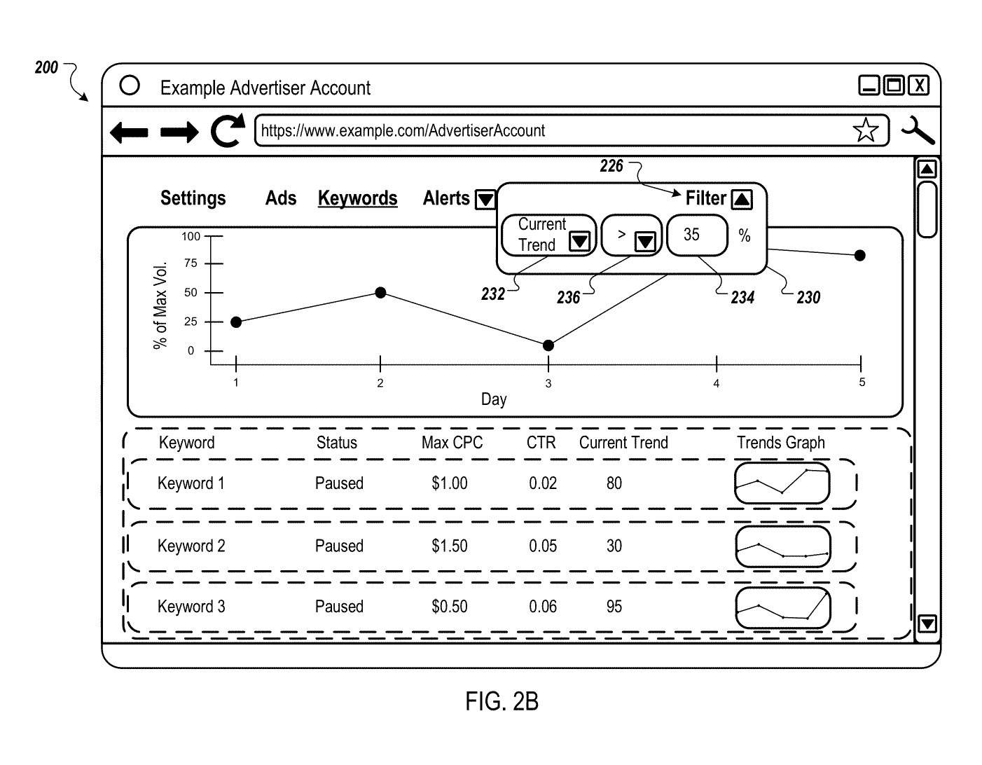

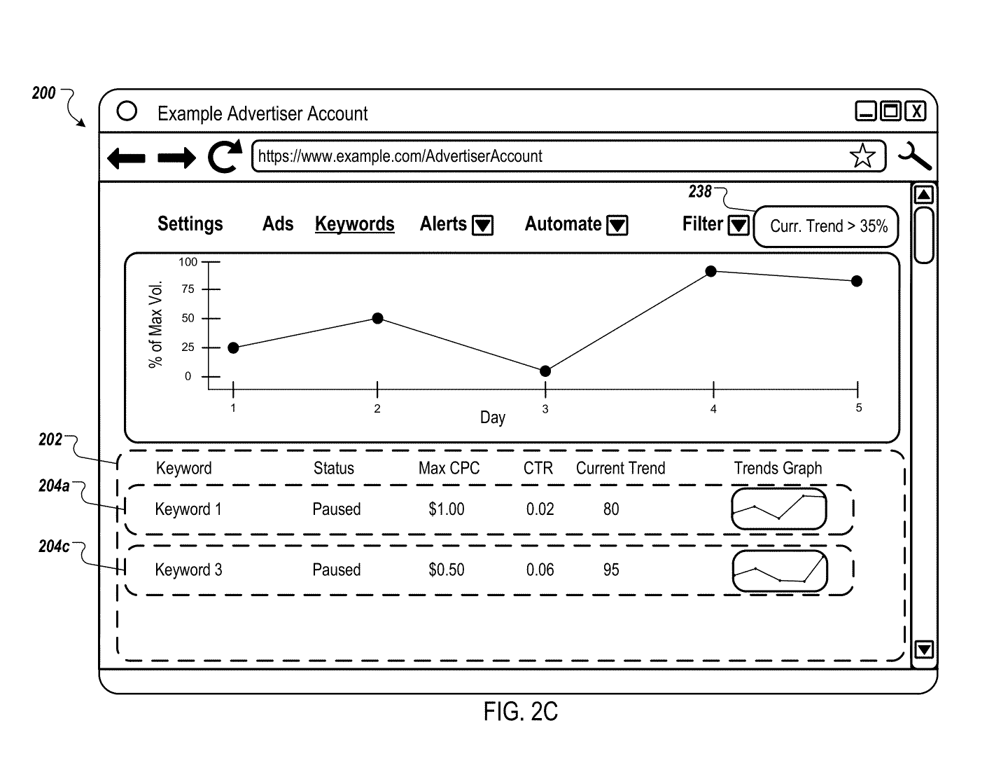

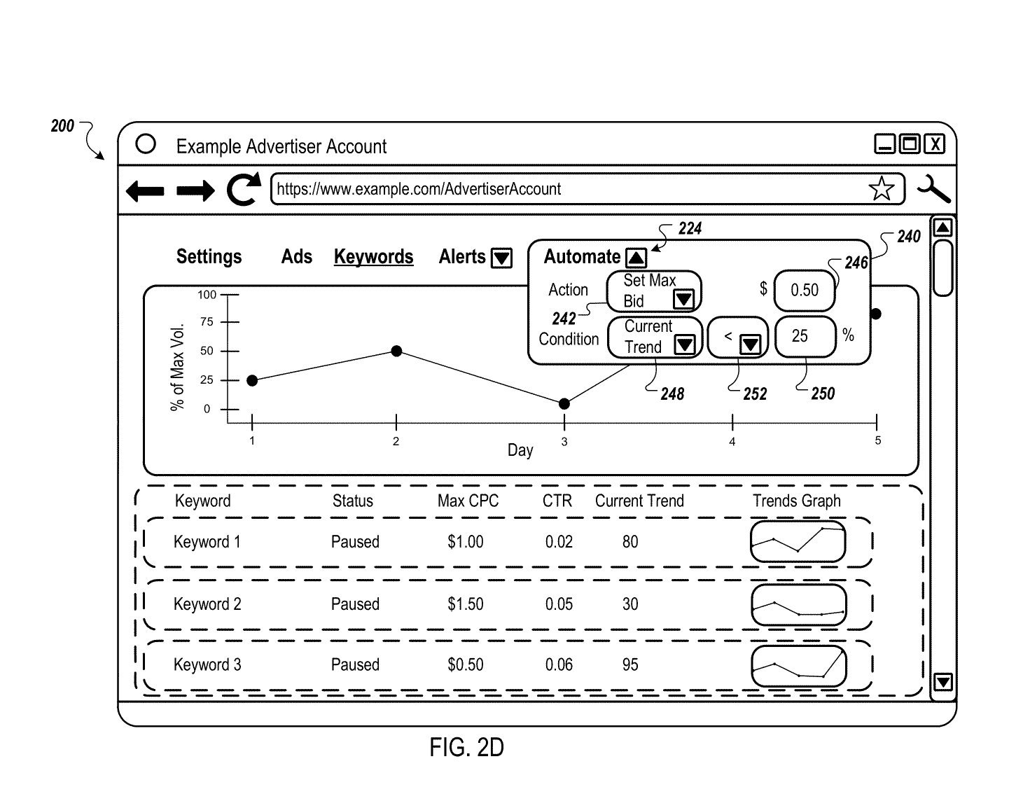

FIG. 2A is a screen shot of an example user interface 200 with which an advertiser can manage distribution of advertisements based on query trend data. The user interface 200 can be provided, for example, by the content distribution system 110 and/or the query trend apparatus 122.

The user interface 200 includes a keyword summary portion 202 in which summary information 204a, 204b, and 204c are provided for keywords (e.g., keyword 1, keyword 2, and keyword 3) that an advertiser has specified as distribution keywords for an advertising campaign. The summary information 204a, 204b, and 204c for each distribution keyword can include a status 206 indicting either that the keyword is currently being used to control distribution of advertisements (an active status) or that the keyword is currently not being used to control distribution of advertisements (e.g., a paused or stopped status). The summary information 204a, 204b, and 204c for each distribution keyword can also include bid information 208 indicating a bid that the advertiser has associated with (e.g., specified for) each of the distribution keywords. The bid that the advertiser has associated with each keyword can be a maximum CPC bid, a CPM bid, or another type of bid such as a cost per conversion bid.

The summary information 204a, 204b, and 204c can additionally include performance data 210 for the keyword specifying the performance of advertisements that are presented based on a match between the keyword and a search query. For example, the performance data 210a for keyword 1 indicates that advertisements that have been presented based on a match between the search queries and keyword 1 have a click through rate of 0.02 (2%). The performance data 210 for the keywords can be expressed as a click through rate, a conversion rate, or another value that is indicative of the effectiveness of the advertisements (e.g., average revenue per click, gross revenue, or return on investment).

The summary information 204a, 204b, and 204c includes current trend data 212 and trends graphs 214 for the distribution keywords. For each keyword, current trend data 212a, 212b, and 212c present a value indicative of a number of matching search queries that have been received by the search system, which is referred to as a query volume for the keyword, over a specified period. In some implementations, the query volume that is specified by the current trend data 212 is a current query volume for a most recently ended period of time (e.g., a most recently ended day). For example, the current trend data 212a for keyword 1 can be a value indicative of the number of matching search queries for keyword 1 for the most recently ended day.

In some implementations, the value specified by the current trend data 212 can be determined relative to a baseline value. The baseline value can be, for example, a maximum historical query volume for the keyword. In FIG. 2A, the current trend data 212 are values indicating the current query volume relative to the maximum historical query volume for the keywords. For example, the current trend data 212a for keyword 1 indicates that the current query volume for keyword 1 is 80% of the maximum historical query volume for keyword 1. Similarly, the current trend data 212b indicates that the current query volume for keyword 2 is 30% of the maximum historical query volume for keyword 2, and the current trend data 212c indicates that the current query volume for keyword 3 is 95% of the maximum historical query volume for keyword 3. The maximum historical query volume for each keyword can be different.

In some implementations, the baseline value is an average historical query volume for the keyword. When the baseline value is the average historical query volume, a current query volume of 1.0 can indicate that the current query volume for the keyword equals the average historical query volume for the keyword. Meanwhile, a current query volume less than 1.0 can indicate that the current query volume for the keyword is less than the average historical query volume, and a query volume greater than 1.0 can indicate that the current query volume is greater than the average historical query volume. To illustrate, a current query volume of 2.0 can indicate that the current query volume is two times the average historical query volume.

The summary information 204a, 204b, and 204c include trend graphs 214a, 214b, and 214c that visually represent historical query volumes for keyword 1, keyword 2, and keyword 3. For example, the trend graph 214a indicates that overall the matching query volume for keyword 1 has been trending up (i.e., increasing) over time, but that for a short period the query volume decreased (e.g., between the points A and B on the trend graph).

The user interface 200 includes a trend graph portion 216 in which one or more trend graphs for keywords can be presented. In FIG. 2A, the trend graph portion 216 includes an enlarged version of the trend graph 214a. The trend graph portion 216 of the user interface 200 includes details regarding the scale of the trend graph. For example, the trend graph portion 216 indicates that the vertical scale 218 is a percentage of the maximum query volume for the keyword, and that the horizontal scale 220 is delineated on a per-day basis.

As illustrated in the trend graph portion 216, on day 1 the query volume for keyword 1 was 25% of the maximum historical query volume for keyword 1, while the query volume on day 2 the query volume for keyword 1 was 50% of the maximum historical query volume. At days 3, 4, and 5, respectively, the query volume for keyword 1 was ˜10%, ˜90%, and ˜80% of the historical maximum query volume. Thus, the trend graph portion 216 provides an advertiser with information regarding the number of matching search queries that were received for a particular keyword on a given day, and information on query volume trend for that particular keyword. Therefore, the advertiser can evaluate whether user interest in this particular keyword is trending up, trending down, or staying somewhat consistent over time.

Trend graph for more than one keyword can be simultaneously presented in the trend graph portion 216. Therefore, an advertiser can directly compare user interest in two or more different keywords over time.

The summary information and/or trend graphs discussed throughout this application can also be provided at a group level (e.g., for a set of keywords that have been specified for a particular group of advertisements). In some implementations, the summary information can be aggregated based on the summary information for each of two or more keywords that have been specified for a group of advertisements (or specified for multiple groups of advertisements that are included in a same advertising campaign). For example, the current trend data for a set of keywords corresponding to a same group of advertisements can be a measure of central tendency (e.g., an average, weighted average, or another measure of central tendency) computed using the current trend data for each keyword in the set of keywords. The measure of central tendency (or other information computed using the measure of central tendency) for the set of keywords can be presented in the user interface 200 as summary information for the group of advertisements. Additionally, the summary information discussed throughout this document can be output in the form of a downloadable report or through use of an application programming interface used to communicate with the keyword trending apparatus 122 and/or content distribution system 110.

The user interface 200 includes an alert element 222, an automate element 224, and a filter element 226, through which the advertiser can refine or take action with respect to the information provided by the trend graph. The alert element 224 enables an advertiser to receive notification when the query volume for a particular keyword. In some implementations, interaction with the alert element 222 can cause presentation of an alerts menu in which the advertiser can specify an alert condition and a method by which the advertiser will be notified when the alert condition has been met. For example, the advertiser can specify an alert condition indicating that the advertiser is to be alerted when the query volume for a particular keyword increases above a specified percentage of the historical maximum (or average) query volume or when the query volume increases a specified amount over a particular period (e.g., over a day or a week). Additionally, the advertiser can specify whether the alert is to be sent over e-mail, through text message, or through another type of communications medium. The automate element 224 and the filter element 226 are described below with reference to FIGS. 2B-2D.

FIG. 2B is another screen shot of the example user interface 200. In FIG. 2B, a filter menu 230 is presented. The filter menu 230 is a menu that enables an advertiser to specify filters with which the summary information for the keywords can be filtered. The filter menu 230 can be presented, for example, in response to interaction with the filter element 226. The filter menu 230 includes a data type element 232 that enables the advertiser to specify a type of data to use for purposes of filtering the summary information. For example, as illustrated by FIG. 2B, an advertiser can specify that the current trend data will be used for purposes of filtering the summary information. Other types of data with which the summary information can be filtered include performance data, such as a click through rate data, conversion rate, cost data such as an average cost per click paid for distribution of advertisements using the keywords, and bid information such as a maximum cost per click bid specified for the keywords. Other types of trend data can also be used for purposes of filtering. For example, an average query volume or a minimum query volume can be used for purposes of filtering the summary information for the keywords.

The filter menu 230 also includes a data entry element 234 that enables the advertiser to input a value that will be used for filtering the summary information according to the selected data type. For example, as illustrated by FIG. 2B, the value 35 has been entered into the data entry element 234 indicating that the summary information will be filtered based on a current trend value of 35% (e.g., keywords having a current trend of less than 35% will be removed).

The filter menu 230 also includes an operator element 236 with which the advertiser can specify the operator that will be used for filtering on the value specified in the data entry element 234. For example, as illustrated by FIG. 2B, the operator element 236 indicates that the filtering will be performed based on a current trend value that is greater than 35%. Note that other operators, such as a less than operator, an equal to operator, greater than or equal to operator, or less than or equal to operator can also be used.

FIG. 2C is another screen shot of the example user interface 200. In FIG. 2C, the summary information has been filtered according to the filter that was specified using the filter menu described with reference to FIG. 2B. In particular, the summary information has been filtered such that the summary information 204b for keyword 2 is no longer presented since the current trend for keyword 2 was 30%, which is less than the 35% required by the filter. The summary information 204a and 204c for keywords 1 and 3 are still presented in the summary portion 202 since the current trend for each of keywords 1 and 3 are above the 35% specified by the filter. As illustrated by FIG. 2C, the user interface 200 can include a filter identifier 238 that provides a visual indication of the filter that has been applied to the summary information.

FIG. 2D is another screen shot of the example user interface 200. In FIG. 2D, an automate menu 240 is presented with which an advertiser can specify distribution parameter change conditions that, when met by the keyword trend data (or other specified data), cause the distribution parameters for the keyword to be adjusted. The automate menu 240 can be presented, for example, in response to interaction with the automate element 224. In some implementations, the automate menu 240 enables the advertiser to specify a distribution change condition in which a specified action is performed in response to determining that the keyword trend data for a keyword is within a specified range of values. The automate menu 240 can also be used to specify other actions to be taken based on keyword trend data for a keyword.

To facilitate creation of the distribution change condition, the automate menu 240 includes an action element 242 with which an advertiser can specify a type of action to be taken with respect to a keyword (e.g., keyword 1, which has been selected as indicated by the grey shading). As illustrated by FIG. 2D, the advertiser has selected the action to be setting the maximum bid for the keyword to a value of $0.50, which was specified in a data entry element 246. Other actions that can be specified by the advertiser can include activating the keyword (i.e., using the keyword to control distribution of advertisements) or deactivating the keyword based on the keyword trend data for the keyword.

The automate menu 240 also includes a data type element 248 with which the advertiser can select a type of data that will be used for determining whether the selected action will be performed. As illustrated by FIG. 2D, the current trend data type has been selected for determining whether the “set max bid” action will be performed. Other data types that can be used for determining whether specified actions will be performed include performance data, such as a click through rate data, cost data such as an average cost per click paid for distribution of advertisements using the keywords, and bid information such as a maximum cost per click bid specified for the keywords. Other types of trend data can also be used for purposes of automating the performance of specified actions. For example, an average query volume or a minimum query volume can be used to determine whether a specified action will be performed.

The automate menu 240 also includes another data entry element 250 that enables the advertiser to input a value that will be used for automating changes to distribution parameters for the keyword. For example, as illustrated by FIG. 2D, the value 25 has been entered into the data entry element 250 indicating that the specified action (e.g., a change to the distribution parameters) will be performed based on a current trend value of 25%.

The automate menu 240 also includes an operator element 252 with which the advertiser can specify the operator that will be used for automating actions (e.g., changes to the distribution parameters for the keyword) based on the value specified in the data entry element 250. For example, as illustrated by FIG. 2D, the operator element 252 indicates that the maximum bid for the keyword will be set to $0.50 when the current trend value for the keyword is less than 25%. Note that other operators, such as a greater than operator, an equal to operator, greater than or equal to operator, or less than or equal to operator can also be used.

Assume for purposes of example that the distribution change condition specified in the automate menu 240 was created by the advertiser on a day corresponding to day 1 of the keyword trend graph. In this example, the distribution changer condition would not have been met by the keyword trend data on day 1 or day 2 because the current trend on each of days 1 and 2 was above 25%. On day 3 the current trend for keyword 1 fell below 25%, such that the distribution change condition specified in the automate menu 240 would be determined to have been met. Therefore, on day 3 the maximum bid for keyword 1 would have been set to $0.50 based on the distribution change parameter having been set.

In some implementations, the distribution change condition can specify different bids for different current trend values. In the example above, the distribution change condition could specify that when the current trend reached 45%, the bid could be increased to $1.00, such that the bid increases with increases to the current query and decreases with decreases to the current query.

The distribution parameter change conditions can be used in conjunction with other campaign settings to automate the activation/de-activation of specified keywords, adjust bids based on the current user interest in specified keywords (e.g., as indicated by the current trends for the keywords), or make other changes to the distribution parameters that control distribution of an advertiser's advertisements. In some implementations, an advertiser can restrict the periods of time (e.g., hours, days, or months) during which particular keywords are eligible to be activated, such that only during these specified periods of time will activation of the keywords occur in response to a determination that a distribution parameter change condition has been met.

For example, assume that an advertiser that sells Halloween costumes specifies that the keyword “costume” is only eligible to be activated after September 1^{st} in a given year. Further assume that the advertiser has created a distribution change condition specifying that the keyword “costume” is to be activated when the current trend for the keyword “costume” exceeds 40%. In this example, the keyword “costume” will not be activated prior to September 1 irrespective of the value of the current trend for that keyword. Additionally, once September 1^{st} arrives, the keyword “costume” will not be activated until the current trend for the keyword costume exceeds 40%. To illustrate, if the current trend for the keyword “costume” does not exceed 40% until September 15^{th}, the keyword “costume” will not be activated until September 15^{th}. Thus, using the distribution change conditions alone, or in combination with other campaign settings enables an advertiser to customize their advertising campaign to automatically adjust with changes in user interest, and to more efficiently and effectively distribute their advertisements at times when user interest in their products is at specified levels.

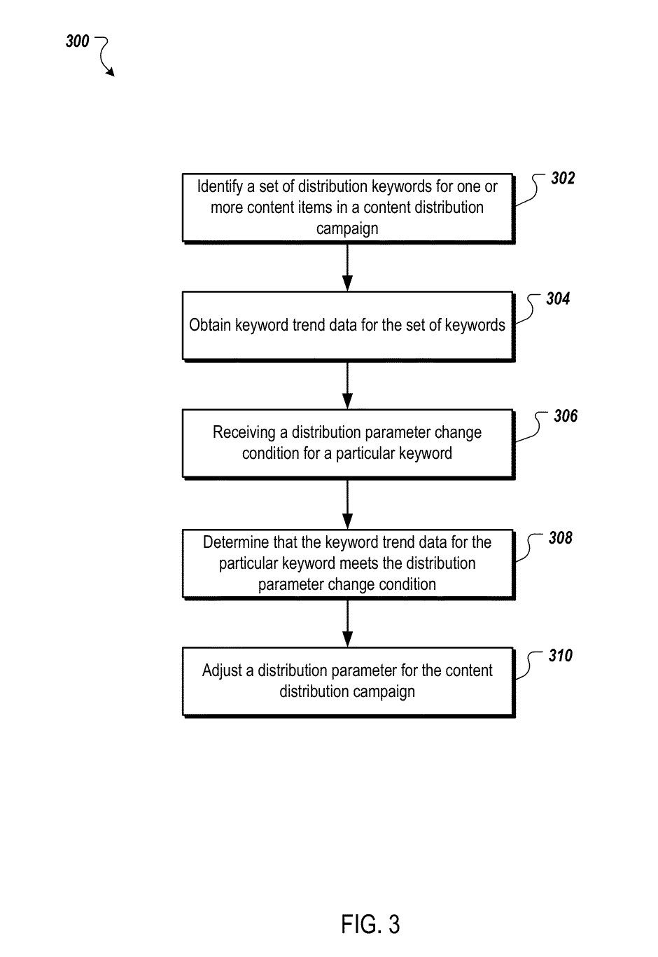

FIG. 3 is a flow chart of an example process 300 for adjusting distribution campaign parameters based on distribution parameter change conditions. The process 300 can be performed, for example, by the keyword trending apparatus 122, the content distribution system 110, or another data processing apparatus. The process 300 can also be implemented as instructions stored on computer storage medium such that execution of the instructions by a data processing apparatus cause the data processing apparatus to perform the operations of the process 300.

A set of distribution keywords for one or more content items is identified (302). In some implementations, the set of distribution keywords are phrases used to control distribution of content items in a content distribution campaign, such as an advertising campaign. The set of distribution keywords can include at least one distribution keyword that must be matched by data included in a content item request in order for a content item to be distributed in response to the content item request.

For example, assume that a set of phrases have been specified as distribution keywords for a particular advertisement (or set of advertisements). Further assume that an advertisement request is received requesting an advertisement to be presented at a user device with a search results page. In this example, the particular advertisement will be selected for presentation with the search results page if a search query, or other data, specified in the advertisement request matches one of the distribution keywords for the particular advertisements. Thus, distribution of the particular advertisement is controlled by the distribution keyword.

Keyword trend data are obtained for the set of keywords (304). The keyword trend data specify, for each of one or more keywords in the set of keywords, a query volume indicative of a number of matching search queries that have been received. In some implementations, query volume is based on the number of matching search queries that are received by a search system over a specified period. For example, the query volume for a particular keyword can be specified based on a number of matching search queries for the particular keyword that are received, by a search system, over a one day period.

In some implementations, the query volume is specified as a relative value that is determined using a baseline query volume as the reference. For example, as discussed above with reference to FIG. 2A, the query volume for a particular keyword can be expressed as a value relative to a historical average query volume for the particular keyword or a value relative to a historical maximum query volume for the particular keyword.

A distribution parameter change condition is received (308). The distribution parameter change condition can be received for one or more particular keywords, and a single distribution parameter change condition can be specified for two or more different keywords. For example, a distribution parameter change condition can be specified at an ad group level or campaign level, such that all keywords that are included in a particular ad group or advertising campaign can have a same distribution parameter change condition. An ad group is a group of one or more advertisements that are grouped together in an advertising campaign and distributed using one or more keywords. An advertising campaign is a set of one or more ad groups that are grouped together into an advertising campaign. Advertisements that are included in a same ad group or advertising campaign can have at least one distribution parameter or another attribute that is specified at the ad group level or the campaign level.

The distribution parameter change condition can be created or defined by the advertiser, and can specify one or more conditions that must be met for a particular action to be performed. The particular action performed can include a change to a distribution parameter for the keyword with which the distribution parameter change condition is associated. The distribution parameters that can be changed include, but are not limited to, a maximum bid associated with a keyword, a status (e.g., active, paused, or deleted) of the keyword, or a particular creative that is presented based on a match of the keyword.

In some implementations, the distribution parameter change condition can be based on one or more characteristics of the keyword trend data for the keyword. The distribution parameter change condition can require, for example, a minimum change in query volume that must occur from a first specified period to a second specified period in order for the distribution parameter change condition to be considered met. For example, an advertiser can specify a distribution parameter change condition that requires at least a 50% increase (or another amount of increase) in the query volume for a particular keyword over from one day to another day (or between two other points in time). The specified minimum change can also be specified as a specified decrease in the query volume between two specified periods.

In some implementations, the distribution parameter change condition specifies an absolute query volume that must occur during a specified period (or over multiple different and possibly consecutive periods) for the distribution parameter change condition to be deemed met. For example, the distribution parameter change condition can require that a current trend (e.g., a query volume for a most recent period) be above (or below) a specified historical query volume (average, maximum, or minimum query volume) in order for the distribution parameter change condition to be deemed met. For instance, with reference to FIG. 2D, the distribution change parameter condition requires that the current trend exceed 25% of the maximum historical query volume for the keyword.

The distribution parameter change condition that is received can include a distribution start condition for a particular keyword, ad group, or campaign. The distribution start condition specifies one or more conditions that when met cause one or more keywords to be eligible to control distribution of content items. In some implementations, the distribution start condition specifies that a particular keyword is eligible to control distribution of content items when the query volume for the particular keyword, as indicated by the keyword trend data, increases to a specified query volume. The increase can be specified, for example, based on a change between two periods or as an increase to a particular specified query volume irrespective of the query volume for the keyword during previous periods.

A determination is made that the keyword trend data for the particular keyword meets the distribution parameter change condition (308). The determination that the keyword trend data meets the distribution parameter change condition can be made based on a comparison of the query volume specified by the keyword trend data and the query volume required by the distribution parameter change condition.

For example, when the distribution parameter change condition specifies a minimum change in query volume that must occur from a first period to a second period, the distribution parameter change condition can be deemed to be met when the change in the query volume from the first period to the second period meets or exceeds the specified minimum change in query volume. To illustrate, assume that the keyword trend data for a particular keyword indicates that from one day to a next day the query volume for the particular keyword increased from 25% of the average historical query volume for the particular query to 200% of the average historical query volume. Further assume that the distribution parameter change condition specifies that the query volume must increase by at least 50% between two days in order for the distribution parameter change condition to be met. In this example, the increase in query volume from the first day to the next day is more than 50%, such that the distribution parameter change condition can be determined to be met.

When the distribution parameter change condition specifies a query volume that must be met, the determination that the distribution parameter change condition is met can be made by comparing the query volume for a most recent period, as specified by the keyword trend data, to the specified query volume to determine whether the query volume meets the specified query volume.

A distribution parameter for the content distribution campaign is adjusted (310). In some implementations, the adjustment is performed in response to (e.g., after) determining that the keyword trend data meets a distribution parameter change condition. The distribution change parameter that is adjusted can be, for example, a distribution parameter that, in combination with a keyword, controls distribution of at least one advertisement (or other content item).

In some implementations, the distribution parameter that is adjusted is a bid (e.g., a maximum bid) that is used as part of an auction to select which advertisement will be presented in response to an advertisement request. For example, as described above with reference to FIG. 2D, the bid for a particular keyword can be set to a specified amount when the query volume for the particular keyword reaches a specified query volume, or when the query volume for the keyword increases at least a specified amount from one period to another.

In addition to, or instead of, specifying a particular value to which the bid for a keyword is adjusted, an advertiser can specify a volume dependent bid that varies according to changes in the query volume for the keyword. For example, an advertiser can specify that the bid for a particular keyword should increase 10% for each 5% increase in query volume for the particular keyword. The advertiser can further specify that the bid for the particular keyword should decrease 10% for each 5% decrease in query volume for the particular keyword. Thus, the bid specified in this example is proportional to the query volume for the particular keyword such that the bid increases with increases to the query volume and the bid decreases with reductions in the query volume.

If the advertiser specifies a query volume dependent bid, the adjustment of the bid will first require that the value of the bid be computed. In this example, the value of the bid can be determined based on the query volume for the keyword and the specified relationship between the query volume and the query dependent bid. In turn, the bid for the keyword can be set to (or set to a value based on) the computed value.

As described above, the query parameter change condition can include a distribution start condition for a particular keyword. When the distribution start condition is determined to be met, the adjustment of the distribution parameter can include enabling the particular keyword to control distribution of a content item (e.g., an advertisement) in a content distribution campaign (e.g., an advertising campaign). The enabling of the particular keyword to control distribution of a content item can be performed in response to determining that the query volume for the particular keyword meets a specified query volume and/or that a change in the query volume from one period to another period meets a minimum query volume change that has been specified.

A query parameter change condition can also specify a distribution stop condition for a particular keyword. When the distribution stop condition is determined to be met, the adjustment of the distribution parameter can include disabling the particular keyword to prevent the particular keyword from controlling distribution of a content item (e.g., an advertisement) in a content distribution campaign (e.g., an advertising campaign). The disabling of the particular keyword can be performed in response to determining that the query volume for the particular keyword meets a specified query volume and/or that a change in the query volume from one period to another period meets a minimum query volume change that has been specified.

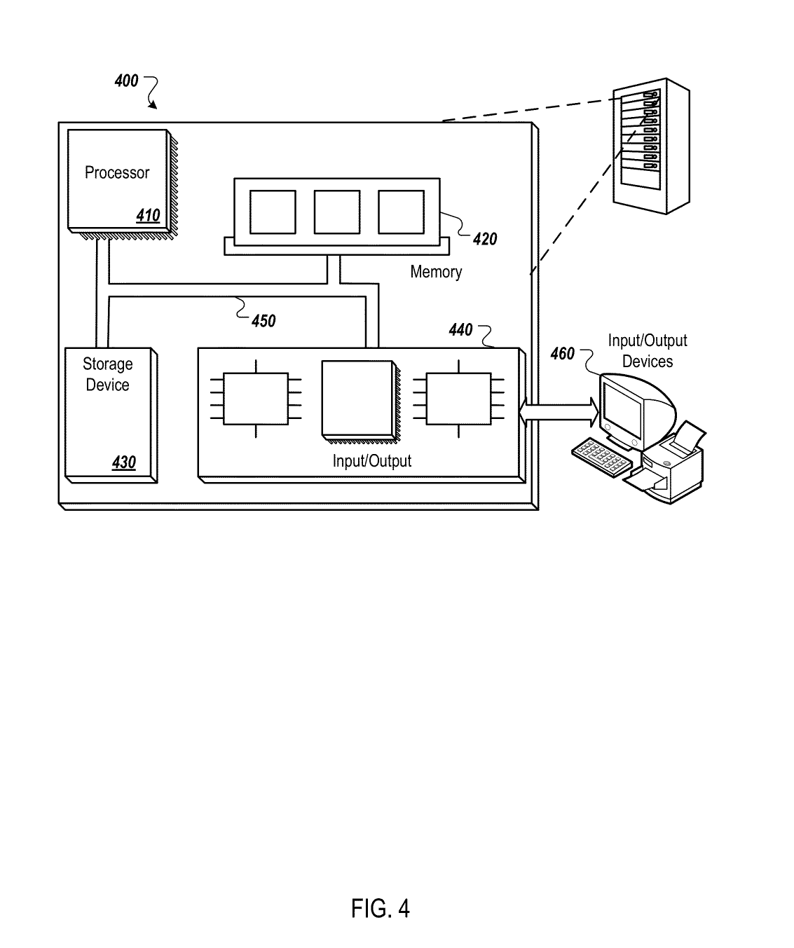

FIG. 4 is block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
identifying a set of keywords for one or more content items that are included in a content distribution campaign, the set of keywords including at least one keyword that must be matched by data included in a content item request for the content item to be distributed in response to the content item request;
obtaining keyword trend data for the set of keywords, the keyword trend data specifying, for each of one or more keywords in the set of keywords, a query volume indicative of a number of matching search queries that have been received, at a search system, over a specified period;
determining, for a particular keyword from the set of keywords and by a data processing apparatus, that the keyword trend data meets a distribution parameter change condition; and
adjusting, by a data processing apparatus and in response to determining that the keyword trend data meets a distribution parameter change condition, a distribution parameter that, in combination with the particular keyword, controls distribution of at least one of the content items.

2. The method of claim 1, wherein obtaining keyword trend data for the set of keywords comprises obtaining, for each keyword among the one or more keywords, a measure of query volume over a specified period, the measure of query volume specifying, for the specified period, a volume of queries received for the specified period relative to a baseline query volume for the keyword.

3. The method of claim 2, wherein determining that the keyword trend data meets a distribution parameter change condition comprises:
receiving, for the particular keyword, a distribution parameter change condition specifying a minimum change in query volume that must occur, from a first specified period to a second specified period, for the distribution change condition to be met; and
determining, based on the keyword trend data, that the change in query volume for the particular keyword meets the minimum change in query volume.

4. The method of claim 1, further comprising:
determining, based on the keyword trend data, a query volume dependent bid for a particular keyword, wherein:
adjusting the distribution parameter comprises setting a bid for the particular keyword to the query volume dependent bid.

5. The method of claim 4, wherein determining the query volume dependent bid comprises computing a value for the query volume dependent bid based on the query volume for the particular keyword, the computed value being proportional to the query volume.

6. The method of claim 4, wherein:
determining that the keyword trend data meets the distribution parameter change condition comprises determining, for the particular keyword, that the query volume meets a specified query volume; and
setting the bid for the particular keyword comprises setting the bid for the particular keyword to a value that has been specified as the volume dependent bid for the specified query volume.

7. The method of claim 1, further comprising:
receiving a distribution start condition specifying that the particular keyword becomes eligible to control distribution of content items when an increase in the query volume for the particular keyword meets a specified query volume; and
determining that the query volume for the particular keyword meets the specified query volume, wherein:
adjusting the distribution parameter comprises enabling the particular keyword to control distribution of a content item in the content distribution campaign, the adjusting being performed in response to determining that the query volume for the particular keyword meets the specified query volume.

8. The method of claim 1, further comprising:
providing a user interface that includes an automate menu in which the distribution parameter change condition is defined; and
receiving, through the user interface, the distribution parameter change condition, the received distribution parameter change condition specifying at least one action that is to be performed in response to determining that the query volume for a particular keyword meets a specified query volume.

9. A computer storage medium encoded with a computer program, the program comprising instructions that when executed by data processing apparatus cause the data processing apparatus to perform operations comprising:
identifying a set of keywords for one or more content items that are included in a content distribution campaign, the set of keywords including at least one keyword that must be matched by data included in a content item request for the content item to be distributed in response to the content item request;
obtaining keyword trend data for the set of keywords, the keyword trend data specifying, for each of one or more keywords in the set of keywords, a query volume indicative of a number of matching search queries that have been received, at a search system, over a specified period;
determining, for a particular keyword from the set of keywords, that the keyword trend data meets a distribution parameter change condition; and
adjusting, in response to determining that the keyword trend data meets a distribution parameter change condition, a distribution parameter that, in combination with the particular keyword, controls distribution of at least one of the content items.

10. The computer storage medium of claim 9, wherein obtaining keyword trend data for the set of keywords comprises obtaining, for each keyword among the one or more keywords, a measure of query volume over a specified period, the measure of query volume specifying, for the specified period, a volume of queries received for the specified period relative to a baseline query volume for the keyword.

11. The computer storage medium of claim 10, wherein determining that the keyword trend data meets a distribution parameter change condition comprises:
receiving, for the particular keyword, a distribution parameter change condition specifying a minimum change in query volume that must occur, from a first specified period to a second specified period, for the distribution change condition to be met; and
determining, based on the keyword trend data, that the change in query volume for the particular keyword meets the minimum change in query volume.

12. The computer storage medium of claim 9, further comprising:
determining, based on the keyword trend data, a query volume dependent bid for a particular keyword, wherein:
adjusting the distribution parameter comprises setting a bid for the particular keyword to the query volume dependent bid.

13. The computer storage medium of claim 12, wherein determining the query volume dependent bid comprises computing a value for the query volume dependent bid based on the query volume for the particular keyword, the computed value being proportional to the query volume.

14. The computer storage medium of claim 12, wherein:
determining that the keyword trend data meets the distribution parameter change condition comprises determining, for the particular keyword, that the query volume meets a specified query volume; and
setting the bid for the particular keyword comprises setting the bid for the particular keyword to a value that has been specified as the volume dependent bid for the specified query volume.

15. The computer storage medium of claim 9, further comprising:
receiving a distribution start condition specifying that the particular keyword becomes eligible to control distribution of content items when an increase in the query volume for the particular keyword meets a specified query volume; and
determining that the query volume for the particular keyword meets the specified query volume, wherein:
adjusting the distribution parameter comprises enabling the particular keyword to control distribution of a content item in the content distribution campaign, the adjusting being performed in response to determining that the query volume for the particular keyword meets the specified query volume.

16. The computer storage medium of claim 9, further comprising:
providing a user interface that includes an automate menu in which the distribution parameter change condition is defined; and
receiving, through the user interface, the distribution parameter change condition, the received distribution parameter change condition specifying at least one action that is to be performed in response to determining that the query volume for a particular keyword meets a specified query volume.

17. A system comprising:
a data store storing keyword trend data specifying, for each of one or more keywords in the set of keywords, a query volume indicative of a number of matching search queries that have been received, at a search system, over a specified period;
one or more data processing apparatus coupled to the data store, the one or more computers including instructions that cause the one or more data processing apparatus to perform operations including:
identifying a set of keywords for one or more content items that are included in a content distribution campaign, the set of keywords including at least one keyword that must be matched by data included in a content item request for the content item to be distributed in response to the content item request;
obtaining the keyword trend data for the set of keywords;
determining, for a particular keyword from the set of keywords, that the keyword trend data meets a distribution parameter change condition; and
adjusting, in response to determining that the keyword trend data meets a distribution parameter change condition, a distribution parameter that, in combination with the particular keyword, controls distribution of at least one of the content items.

18. The system of claim 17, wherein obtaining the keyword trend data for the set of keywords comprises obtaining, for each keyword among the one or more keywords, a measure of query volume over a specified period, the measure of query volume specifying, for the specified period, a volume of queries received for the specified period relative to a baseline query volume for the keyword.

19. The system of claim 18, wherein determining that the keyword trend data meets a distribution parameter change condition comprises:
receiving, for the particular keyword, a distribution parameter change condition specifying a minimum change in query volume that must occur, from a first specified period to a second specified period, for the distribution change condition to be met; and
determining, based on the keyword trend data, that the change in query volume for the particular keyword meets the minimum change in query volume.

20. The system of claim 17, wherein the instructions cause the one or more data processing apparatus to perform operations comprising:
determining, based on the keyword trend data, a query volume dependent bid for a particular keyword, wherein:
adjusting the distribution parameter comprises setting a bid for the particular keyword to the query volume dependent bid.

21. The system of claim 20, wherein determining the query volume dependent bid comprises computing a value for the query volume dependent bid based on the query volume for the particular keyword, the computed value being proportional to the query volume.

22. The system of claim 20, wherein:
determining that the keyword trend data meets the distribution parameter change condition comprises determining, for the particular keyword, that the query volume meets a specified query volume; and
setting the bid for the particular keyword comprises setting the bid for the particular keyword to a value that has been specified as the volume dependent bid for the specified query volume.

23. The system of claim 17, wherein the instructions cause the one or more data processing apparatus to perform operations comprising:
receiving a distribution start condition specifying that the particular keyword becomes eligible to control distribution of content items when an increase in the query volume for the particular keyword meets a specified query volume; and
determining that the query volume for the particular keyword meets the specified query volume, wherein:
adjusting the distribution parameter comprises enabling the particular keyword to control distribution of a content item in the content distribution campaign, the adjusting being performed in response to determining that the query volume for the particular keyword meets the specified query volume.

24. The system of claim 17, wherein the instructions cause the one or more data processing apparatus to perform operations comprising:
providing a user interface that includes an automate menu in which the distribution parameter change condition is defined; and
receiving, through the user interface, the distribution parameter change condition, the received distribution parameter change condition specifying at least one action that is to be performed in response to determining that the query volume for a particular keyword meets a specified query volume.
